(19) United States
(12) Patent Application Publication
(10) Pub. No.: US 2016/0338475 A1
(43) Pub. Date: Nov. 24, 2016

(54) Customizable Nutrition, Equipment, Supply and Endurance System

(71) Applicant: The Original WarriorPak, LLC, Lodi, CA (US)

(72) Inventors: Tracey Hayes, Irvine, CA (US); Kelly Jacobson, Irvine, CA (US)

(73) Assignee: The Original WarriorPak, LLC, Lodi, CA (US)

(21) Appl. No.: 15/160,415

(22) Filed: May 20, 2016

Related U.S. Application Data
(60) Provisional application No. 62/165,147, filed on May 21, 2015.

(51) Int. Cl. A45F 3/16; A41B 11/00; H02J 7/35; A41D 1/00; A45F 3/04; G01S 19/13; A41D 19/00; A42B 1/00

(52) U.S. Cl. CPC A45F 3/16; A41D 19/00; A41B 11/00; A42B 1/00; A41D 1/00; A45F 3/04; G01S 19/13; H02J 7/35; A45F 2003/166

(57) ABSTRACT

A customizable nutrition, equipment, supply and endurance system has been developed and may include: at least one nutrition component, at least one piece of race or challenge gear or race or challenge equipment, at least one hydration component; and a lightweight pack or bag that can be easily secured or carried on the back of a walker or runner without interfering with the walker or runner when not in use. Methods of providing a customizable nutrition, equipment, supply and endurance system are also disclosed and include: providing at least one nutrition component, providing at least one piece of race or challenge gear or race or challenge equipment, providing at least one hydration component; providing a lightweight pack or bag that can be easily secured or carried on the back of a walker or runner without interfering with the walker or runner when not in use; and combining the at least one nutrition component, the at least one piece of race or challenge gear or race or challenge equipment and the at least one hydration component in the lightweight pack or bag, such that the system is intentionally tailored to a specific race or challenge.

This U.S. Utility application claims priority to U.S. Provisional Patent Application Ser. No. 62/165,147 filed on May 21, 2015 and entitled “Nutrition, Equipment, Supply and Endurance System”, which is commonly-owned and incorporated by reference in its entirety.

### FIELD OF THE SUBJECT MATTER

The field of the subject matter is a consolidated and customizable system for providing nutrition, equipment, supplies and endurance tools for participants in fitness and obstacle activities and races.

### BACKGROUND

Endurance and obstacle races and activities are more popular now than ever, and these races vary with respect to both length and degree of difficulty. In all instances, a runner is being tested as to his or her ability to get from start to finish as quickly as possible. In some instances, races include obstacles on the path from start to finish that the runner must traverse in order to successfully finish the race.

Runners use all sorts of methods to store equipment and food for these races, including a runner's belt, which is able to hold 1-2 nutrition bars and a phone—at best, pockets in a jacket, shirt or shorts or in some instances, friends, family or coaches strategically positioned on the race path to hold items the runner may need. Some runners just rely on water, sports drink and nutrition stations positioned on the course. These stations are often unreliable, in that they may not have enough of them and/or they may run out of supplies before the runner reaches them. For many runners, none of these conventional systems suit all of the runner's needs during a race.

For new runners or racers, they do not know what they need for the race until they are participating in the race. While they may train and read articles on what would be good to carry during the race, many runners don't know what they needed until the race is complete. Therefore, a system that is initially customizable, but also suggests what the runner or racer needs for each type of race, is ideal. So, if the runner indicates that he or she is running a half marathon, the options will be different than if the runner indicates that he or she is running a marathon or an Ironman Triathalon.

It would be ideal to have a lightweight, well-designed, customizable and targeted system that allows the runner or competitor to store, carry and access all of the items needed for the race, course or activity where the runner or walker is competing. A contemplated ideal system should be able to hold food or nutrition items, water or sports drinks, gear and equipment, such as gloves, compression garments, tape, socks, hats, sunglasses, etc. This contemplated ideal system should not be unnecessarily heavy, should be able to be carried in an efficient and balanced manner and should be easy to access either while running/walking or at a quick stop. An ideal system should be one that can be stored before the race easily and efficiently or carried/worn during the race by the participant. An ideal system may also include a tracking device that can be activated by the runner or competitor during the race or activity.

### SUMMARY OF THE SUBJECT MATTER

A customizable nutrition, equipment, supply and endurance system has been developed and may include: at least one nutrition component, at least one piece of race or challenge gear or race or challenge equipment, at least one hydration component; and a lightweight pack or bag that can be easily secured or carried on the back of a walker or runner without interfering with the walker or runner when not in use.

Methods of providing a customizable nutrition, equipment, supply and endurance system are also disclosed and include: providing at least one nutrition component, providing at least one piece of race or challenge gear or race or challenge equipment, providing at least one hydration component; providing a lightweight pack or bag that can be easily secured or carried on the back of a walker or runner without interfering with the walker or runner when not in use; and combining the at least one nutrition component, the at least one piece of race or challenge gear or race or challenge equipment and the at least one hydration component in the lightweight pack or bag, such that the system is intentionally tailored to a specific race or challenge.

### BRIEF DESCRIPTION OF THE DRAWINGS

FIG. 1 shows a contemplated system.

FIG. 2 shows a contemplated system.

FIG. 3 shows a contemplated system.

### DETAILED DESCRIPTION

A new system has been developed and is disclosed herein that is a lightweight, and well-designed, and that allows the runner or competitor to store, carry and access all of the items needed for the race, course or activity where the runner or walker is competing. The contemplated systems disclosed herein are designed to hold food or nutrition items, water or sports drinks, gear and equipment, such as gloves, compression garments, tape, socks, hats, sunglasses, etc. These contemplated systems are not unnecessarily heavy, are able to be carried in an efficient and balanced manner and are easy to access either while running/walking or at a quick stop. Contemplated systems can be stored before the race easily and efficiently or carried/worn during the race by the participant. A contemplated system may also include a tracking device that can be activated by the runner or competitor during the race or activity.

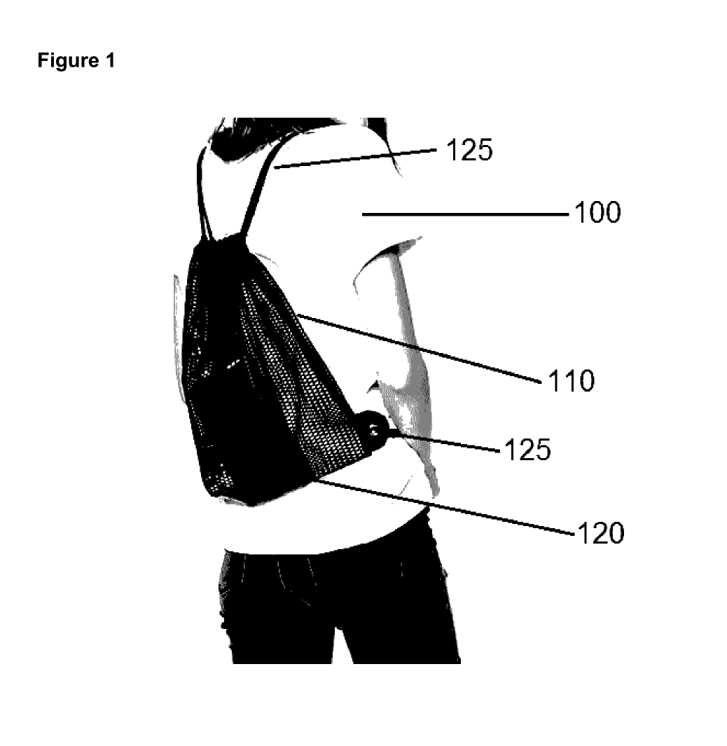

Contemplated systems are shown in FIG. 1 and begin with a lightweight pack or bag 110 that can be easily secured and/or carried on the back of the walker or runner 100. As shown in FIG. 1, a contemplated bag has at least one strap 125 to secure the bag 110 to the user 100, and has a pouch area 120 for holding and containing contemplated items that are a part of the system.

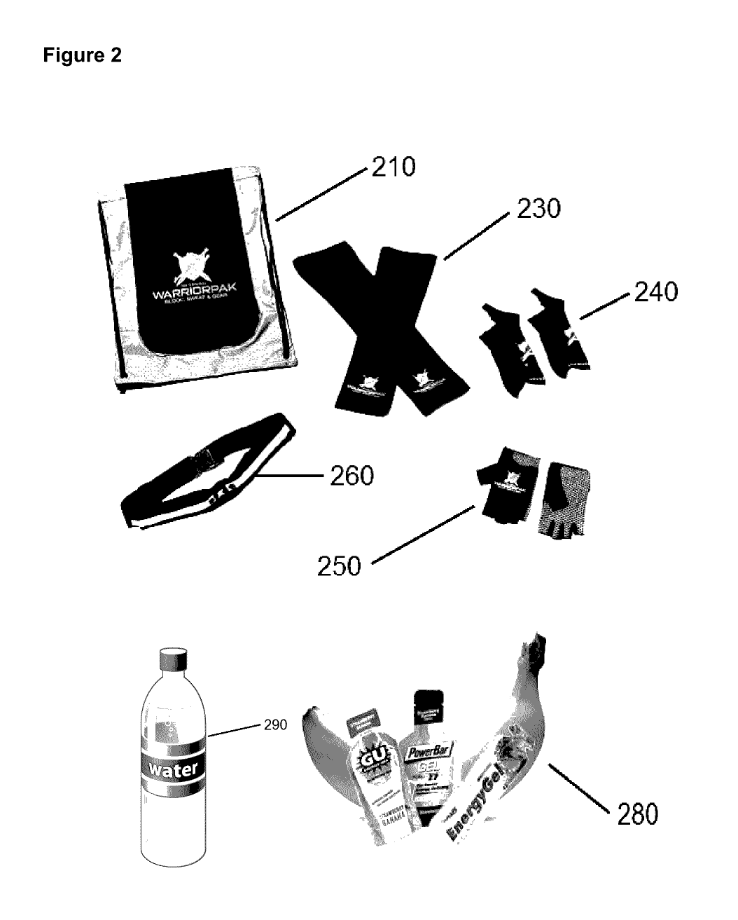

A customizable nutrition, equipment, supply and endurance system has been developed and may include: at least one nutrition component, at least one piece of race or challenge gear or race or challenge equipment, at least one hydration component; and a lightweight pack or bag that can be easily secured or carried on the back of a walker or runner without interfering with the walker or runner when not in use. FIG. 2 shows a contemplated system comprising a lightweight pack 210, compression socks or sleeves 230, socks 240, gloves 250, a race belt 260, a hydration source 290 and a nutrition source 280.

Contemplated packs can be drawstring bags, streamlined backpacks or lightweight bags that may contain built in bladders for holding water or sports drinks; however, it should be understood that many of the contemplated systems do not contain those bladders, because the systems are designed to be fully disposable/discardable. These packs or bags are usually made from a synthetic material, such as nylon, in order to keep them lightweight and able to be washed without shrinking or becoming deformed.

Contemplated systems are superior to conventional methods of storing these items during races, because they allow the walker or runner to fully compete without bulky or randomly stored equipment and nutrition items, they allow the walker or runner to easily and quickly access various items needed for each stage of the race, and they allow the walker or runner to customize his or her system to his or her needs. Some of the items that are stored in the system are designed for single use, such as nutrition bars or tape, and some of the items are designed for multiple uses, such as compression garments, hats, sunglasses, cell phones or gloves. Contemplated systems may include gloves, compression sleeves, compression socks, racing shoes, a race belt, at least one protein bar, energy or electrolyte chews, sunscreen, aspirin or Ibuprofen, band aids, SPF lip balm, towels or cloths, hydration or water sources, KT tape, waterproof cameras, a hat, extra clothes, among other items.

Contemplated customizable nutrition, equipment, supply and endurance systems may comprise an integrated global positioning software or GPS tracker. Contemplated GPS trackers may be used on their own and independently from the race or event or may be synchronized with the race or event to provide tracking information and timing information.

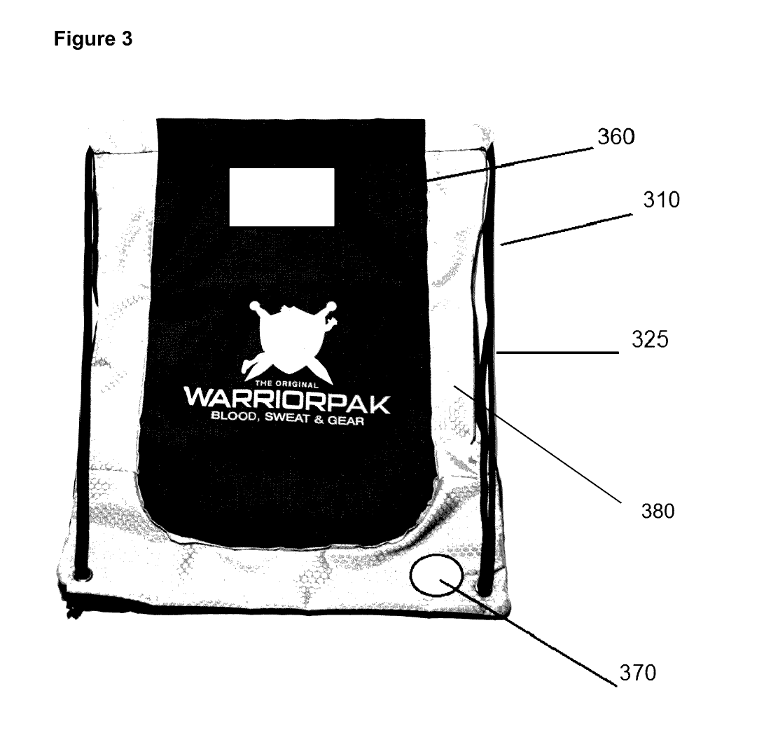

In other contemplated systems, the pack or bag comprises an integrated solar charger for wireless communications components. In both of these instances, it should be understood that the components are a part of the system, because they are directly associated with race or endurance challenges, in that they need to be tracked or may need to camp overnight during longer races. FIG. 3 shows a contemplated pack or bag 310 for a contemplated system, wherein the bag or pack 310 comprises at least one strap or string 325 to secure the bag 310 to the user (not shown), at least one integrated solar charger 360, at least one integrated GPS tracker 370 and at least one integrated emergency indicator, which in this instance is reflective material 380.

It should be understood that a contemplated system isn't one that just includes the storage bag, but is one that includes at least two items directed to assisting the walker or runner during a race. So, a Camelbak™ bag designed to hold water or sports drink is not contemplated by systems disclosed herein, because these systems provide harnesses and additional weight that is not contemplated by systems herein. In addition, contemplated systems come or are complete for the runner's or walker's specifications. In addition, one of the drawbacks of the Camelbak™ system is that it is expensive. Therefore, if a runner needs to discard the system during a race—for whatever reason—the Camelbak™ system would not be ideal for that purpose.

Methods of providing a customizable nutrition, equipment, supply and endurance system are also disclosed and include: providing at least one nutrition component, providing at least one piece of race or challenge gear or race or challenge equipment, providing at least one hydration component; providing a lightweight pack or bag that can be easily secured or carried on the back of a walker or runner without interfering with the walker or runner when not in use; and combining the at least one nutrition component, the at least one piece of race or challenge gear or race or challenge equipment and the at least one hydration component in the lightweight pack or bag, such that the system is intentionally tailored to a specific race or challenge. This method is exemplified by combining the items shown in FIG. 2, for example, into the pack or bag of FIG. 3 to provide the user with the system shown in FIG. 1.

As mentioned earlier, new runners or racers, they do not know what they need for the race until they are participating in the race. While they may train and read articles on what would be good to carry during the race, many runners don't know what they needed until the race is complete. Therefore, a system that is initially customizable, but also suggests what the runner or racer needs for each type of race, is contemplated herein. So, if the runner indicates that he or she is running a half marathon, the options will be different than if the runner indicates that he or she is running a marathon or an Ironman Triathalon. In addition, the racer, walker or runner can select a customizable or customized system that is tailored for a half marathon in Palm Springs or Arizona (flat, desert terrain and heat) versus a half marathon in Boston, Mass. (city, colder/rain) versus a half marathon in Virginia (rural, hills, humid). It should be understood that each of these half marathons will require different nutritional and hydration needs, not to mention additional or less equipment or gear or different equipment or gear.

Thus, specific embodiments of customizable and tailored nutrition, equipment, supply and endurance systems have been disclosed. It should be apparent, however, to those skilled in the art that many more modifications besides those already described are possible without departing from the inventive concepts herein. The inventive subject matter, therefore, is not to be restricted except in the spirit of the disclosure herein. Moreover, in interpreting the specification, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

We claim:

1. A customizable nutrition, equipment, supply and endurance system, comprising:
at least one nutrition component,
at least one piece of race or challenge gear or race or challenge equipment,
at least one hydration component; and
a lightweight pack or bag that can be easily secured or carried on the back of a walker or runner without interfering with the walker or runner when not in use.

2. The customizable nutrition, equipment, supply and endurance system of claim 1, wherein the pack or bag comprises an integrated global positioning software or GPS tracker.

3. The customizable nutrition, equipment, supply and endurance system of claim 1, wherein the pack or bag comprises an integrated solar charger for wireless communications components.

4. The customizable nutrition, equipment, supply and endurance system of claim 1, wherein the pack or bag comprises at least one integrated emergency indicator component.

5. The customizable nutrition, equipment, supply and endurance system of claim 1, wherein the at least one nutrition component comprises food, sports drinks or a combination thereof.

6. The customizable nutrition, equipment, supply and endurance system of claim 1, wherein the system is disposable, recyclable, discardable or a combination thereof.

7. The customizable nutrition, equipment, supply and endurance system of claim 1, wherein the at least one piece of race or challenge gear or race or challenge equipment comprises gloves, compression garments, tape, socks, hats, sunglasses or a combination thereof.

8. The customizable nutrition, equipment, supply and endurance system of claim 1, wherein the at least one hydration component comprises water, sports drinks or a combination thereof.

9. A method of providing a customizable nutrition, equipment, supply and endurance system, comprising:
providing at least one nutrition component,
providing at least one piece of race or challenge gear or race or challenge equipment,
providing at least one hydration component;
providing a lightweight pack or bag that can be easily secured or carried on the back of a walker or runner without interfering with the walker or runner when not in use; and
combining the at least one nutrition component, the at least one piece of race or challenge gear or race or challenge equipment and the at least one hydration component in the lightweight pack or bag, such that the system is intentionally tailored to a specific race or challenge.

10. The method of claim 9, wherein the pack or bag comprises an integrated global positioning software or GPS tracker.

11. The method of claim 9, wherein the pack or bag comprises an integrated solar charger for wireless communications components.

12. The method of claim 9, wherein the pack or bag comprises at least one integrated emergency indicator component.

13. The method of claim 9, wherein the at least one nutrition component comprises food, sports drinks or a combination thereof.

14. The method of claim 9, wherein the system is disposable, recyclable, discardable or a combination thereof.

15. The method of claim 9, wherein the at least one piece of race or challenge gear or race or challenge equipment comprises gloves, compression garments, tape, socks, hats, sunglasses or a combination thereof.

16. The method of claim 9, wherein the at least one hydration component comprises water, sports drinks or a combination thereof.
